(19) United States
(12) Patent Application Publication
(10) Pub. No.: US 2004/0009266 A1
(43) Pub. Date: Jan. 15, 2004

(54) Colored multi-layer food product and kit

(76) Inventors: Laureen S. Violi, McMurray, PA (US); Rocco J. Violi, McMurray, PA (US)

Correspondence Address: Lorri W. Cooper, Jones, Day, Reavis & Pogue, North Point, 901 Lakeside Avenue, Cleveland, OH, 44114, US

(21) Appl. No.: 10/266,390

(22) Filed: Oct. 8, 2002

Related U.S. Application Data
(60) Provisional application No. 60/395,391, filed on Jul. 12, 2002.

(51) Int. Cl. A23G 3/00

(52) U.S. Cl. 426/94

(57) ABSTRACT

A pizza comprises a crust having a first color and a traditional color, a sauce having a second color and a traditional color, and a cheese having a third color and a traditional color. At least one of the first color, the second color, and the third color are fundamentally different from the corresponding traditional color. A pizza kit includes a plurality of crusts, a plurality of packages of sauce, and a plurality of packages of cheese. Each crust within the plurality of crusts has a color that is different from an original color of the crusts. Each sauce has a color that is different from an original color of the sauce. And each cheese has a third color that is different from an original color of the cheese. Toppings may be included on the pizza. The toppings may have a color that is fundamentally different from the traditional color of the toppings.

### CROSS-REFERENCE TO RELATED APPLICATIONS

This application claims the benefit of U.S. Provisional Application No. 60/395,391, filed Jul. 12, 2002, the disclosure of which is incorporated herein by reference in its entirety.

### FIELD OF THE INVENTION

The claimed invention relates to a multi-layered food product and a kit for assembling a multi-layered food product. In particular, the invention relates to a pizza having components that have colors that are fundamentally altered relative to their traditional colors.

### BACKGROUND OF THE INVENTION

Pizza is traditionally made with a crust, sauce, cheese and optional toppings. A pizza crust traditionally has a light beige to brown color, depending upon whether it has been cooked. Sauce is traditionally red for tomato-based sauces or white/yellow for garlic-based sauces. Cheese is traditionally white, or a variation of white. Toppings come in a variety of colors. Pepperoni is traditionally an orange/red color; sausage and bacon are typically a brown color (when cooked); mushrooms are a white or grey color, depending on whether they are cooked; onions are traditionally white, red or yellow, depending on the type of onion; and olives can be green or black, among other colors.

Recently, colored food products have become popular in the market, especially with children consumers. For instance, H. J. Heinz is marketing a colored Ketchup that alters the natural red color of ketchup to produce a purple and a green colored product. Parkay is marketing colored margarine in blue and pink colors. Motts is marketing colored applesauce packs, that come in blue and green.

### SUMMARY

According to the claimed invention, a multi-layered food product comprises a first food layer having a first color and a traditional color, and a second food layer having a second color and a traditional color. The first color is fundamentally altered from the traditional color of the first food layer and the second food layer is fundamentally altered from the traditional color of the second food layer. The multi-layered food product may also comprise a third food layer having a third color and a traditional color. The third color is fundamentally altered from the traditional color of the third food layer.

According to another embodiment, a pizza comprises a crust having a first color and a traditional color, a sauce having a second color and a traditional color, and a cheese having a third color and a traditional color. At least one of the first color, the second color, and the third color are fundamentally different from the corresponding traditional color.

In yet another embodiment, a pizza kit comprises at least one package comprising a crust, at least one package comprising a sauce, and at least one package comprising a cheese. Each crust has a first color and an original color. Each sauce has a second color and an original color, and each cheese has a third color and an original color. At least one of the first color, the second color, and the third color are fundamentally different from their corresponding original color.

In a further embodiment, a multi-layered food product kit comprises a plurality of first food layers and a plurality of second food layers. Each first food layer has a color that is fundamentally different from a traditional color of the first food layer. Each second food layer has a color that is fundamentally different from a traditional color of the second food layer.

### BRIEF DESCRIPTION OF THE DRAWING FIGURES

FIG. 1 is a round pizza according to the present invention;

FIG. 2 is a cross-sectional view of the pizza of FIG. 1;

FIG. 3 is a cross-sectional view of an alternative embodiment of cheese bread according to the invention;

FIG. 4 is schematic depiction of a pizza kit according to the invention that includes single serving pizzas; and

FIG. 5 is a schematic depiction of a cheese bread kit according to another embodiment of the invention.

### DETAILED DESCRIPTION OF THE INVENTION

The present invention relates to a multi-layered food product that has components that have been color altered from their natural or traditional color. Such multi-layer food products include pizza 10, cheese bread 40, and layered desserts, among other food products. While the invention is discussed herein in the context of pizza 10 and cheese bread 40, other products may benefit from the teachings herein, the invention not being limited to pizza 10 and cheese bread 40.

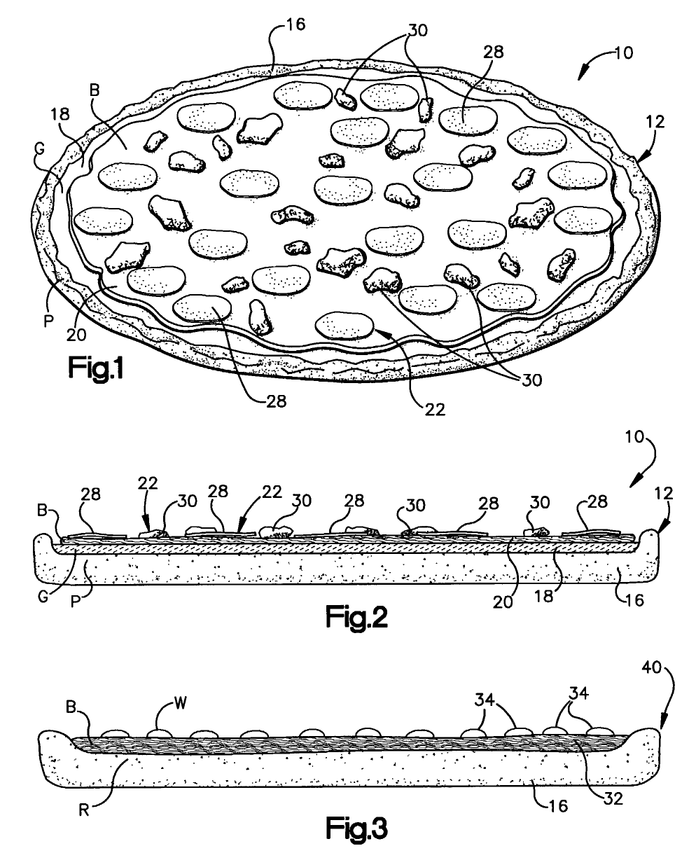

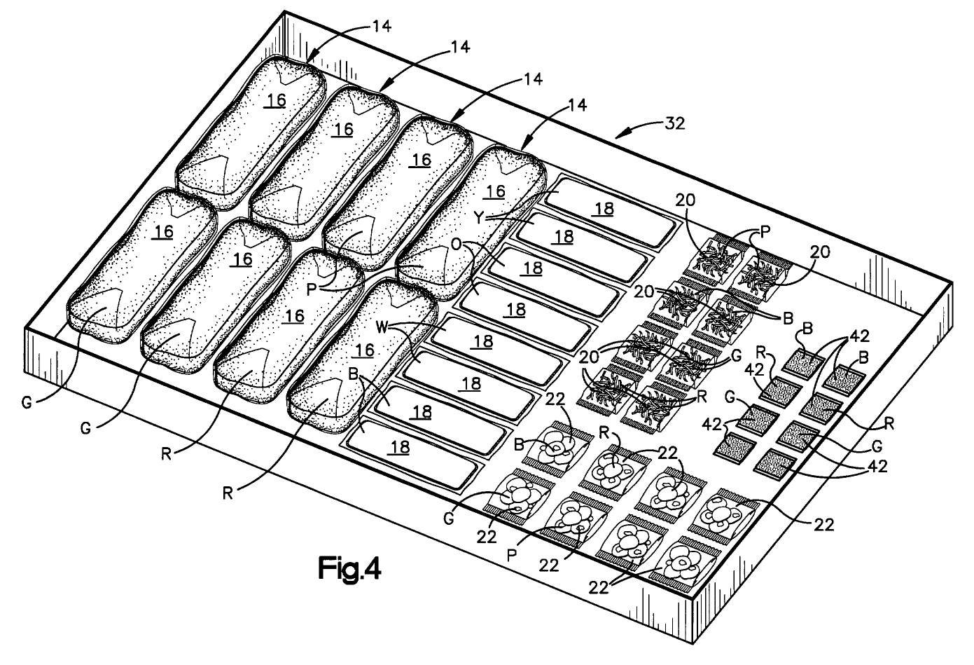

A pizza 10 according to the invention is shown in FIGS. 1, 2, and 4. FIGS. 1 and 2 show a round pizza 12 and FIG. 4 shows multiple personal size pizzas 14, which are depicted as being rectangular in shape. Pizzas 10 have multiple layers, which include a crust 16, a sauce 18, a cheese 20, and optional toppings 22. The crust 16 is traditionally at the bottom of the stack of layers. The sauce 18 covers a majority of the upper surface of the crust 16, and the cheese 20 at least partially covers the sauce 18 and may also cover part of the upper surface of the crust 16. The toppings 22 can be placed under or over the cheese 20, depending upon personal preference.

Crusts 16 have an original color that is traditionally a light beige to brown color, depending on whether the crust 16 has been fully cooked. Original crust colors may also vary depending on the type of flour utilized. For instance, a whole wheat flour is typically browner than a white bleached flour.

Sauce 18 is available in a number of different compositions. One type of sauce 18 is a “red” sauce 24, which is tomato-based, and has an original, traditional color of red. Another type of sauce 18 is a “white” sauce 26, which is typically, a garlic-based sauce. “White” sauce is traditionally a tan/yellow color.

Pizza cheese 20 traditionally has an original color of white, or variations of the shade of white. Traditional pizza cheeses include mozzarella, provolone, parmesan and romano, among others. Other cheeses that may be utilized may have a yellow or orange color, such as cheddar.

Toppings 22 can comprise a number of different ingredients, including cheese, meats, and vegetables. Cheese toppings 22 can be used to make a “double cheese” pizza 10, for example. Cheese toppings 22 can also be used as an accent, such as, for example, parmesan or romano cheese. Meat toppings include, for example, pepperoni 28, sausage 30, bacon, and hamburger, among other meats. Vegetable toppings include onions, mushrooms, olives, and peppers, among other vegetables. Other types of toppings 22 are also known. Each of these toppings 22 has an original and traditional color. For example, pepperoni 28 is typically a reddish/orange color, olives can be black or green, cooked sausage 30 and hamburger are a light brown color, etc.

The present invention takes the known ingredients of a pizza 10 and fundamentally alters the colors of the various ingredients so that they differ from the original and traditional colors. For example, according to the invention, crusts 16 are made in blue B, red R, green G, yellow Y, orange O, purple P, white W, and other colors. Sauce 18 is made in blue B, red R (garlic-based), yellow Y, green G, orange O, purple P, white W and other colors. Cheeses 20 are made in blue B, red R, yellow Y, green G, orange O, purple P and other colors. As is evident, these colors are not traditionally associated with pizza 10. Toppings may also be color altered. For example, pepperoni can be blue B, yellow Y, green G, orange O, purple P, white W, or other colors; mushrooms can be red R, green G, purple P, blue B, yellow Y, orange O, or other colors; etc.

The crust 16 is made from a pizza dough and a colorant. Typical ingredients for the dough include flour, salt, water or milk, oil, preservatives, spices, and yeast. The flour can be bleached, unbleached, or whole wheat. Other types of ingredients may also be utilized in the crust 16, the crust 16 not being limited to any particular recipe.

The sauce 18 is made from a base sauce and a colorant. Two types of sauces 18 are known, including a “red” sauce 24 and a “white” sauce 26. The “red” pizza sauce 24, which is traditionally red in color, typically includes water, tomatoes, tomato paste, oil, salt, garlic, spices and preservatives. The “white” pizza sauce 26, which is traditionally a yellow/tan color, typically includes oil, water, vinegar, salt, egg yolk, spices, garlic, preservatives, and other additives. Other types of ingredients may be used in the sauce 18, the invention not being limited to a particular recipe. Other types of sauce may also be utilized. For instance, a salsa may be substituted for the sauce 18, if so desired.

The cheese 20 is made from a base cheese and a colorant. In a preferred embodiment, the cheese is shredded or otherwise cut into small pieces. Cheese 20 can be a single type of cheese or a blend of cheeses. Typical cheeses 20 used for pizza 10 include mozzarella, provolone, cheddar, parmesan, romano, swiss, and monterey jack, among other cheeses. The cheeses 20 can be whole or reduced fat. Other types of cheeses 20 may be utilized, the invention not being limited to a particular type or combination of cheeses.

The colorant for each of the layers of the pizza can either be a pigment or a dye, in a liquid, a powder, a granular, or another state. The colorant is preferably approved by the Food and Drug Administration for use in food products. Colorants may be natural or synthetic, or a combination of natural and synthetic. Typical colorants include: FD&C Blue No. 1, FD&C Blue No. 2, FD&C Green No. 3, FD&C Red No. 3, FD&C Red No. 40, FD&C Yellow No. 5, FD&C Yellow No. 6, Amaranth, Ponceau 4R, Quinoline Yellow, Patent Blue V, Green S, Brown HT, Black BN, Tumeric, Carotenoid, Annatto, Paprika Oleoresin, Carmine, Anthocyanin-Based, Beet Juice, Caramel, Titanium Dioxide or White Dispersions, or combinations thereof. The colorants may be Lakes, Aluminum Lakes, combinations thereof, or otherwise. Other natural or synthetic colorants may also be utilized, the types of colorants not being limited to this list. Titanium dioxide, a whitener, can be used alone to make a white product, or in combination with other dyes or pigments in order to both whiten and color the product. The colorant can be premixed into the product, can be mixed into the ingredients of the pizza just prior to assembly of the pizza 10, or can be sprinkled on after the ingredients of the pizza are assembled, as will be discussed in greater detail below.

As discussed above, the crust 16 comprises a dough mixture and a colorant. The colorant, whether in liquid or powder form, is preferably mixed into the dough prior to baking. The color of the crust 16 may change slightly during baking, but the primary color of the colorant predominates. The sauce 18, which comprises a base sauce and a colorant, is also preferably premixed, such that the colorant is mixed into the sauce 18 and then the sauce 18 is applied to the crust 16. The crust 16 can be partially baked (par-baked) before the sauce 18 is applied, or can be unbaked.

The cheese 20 includes a shredded base cheese and a colorant. The colorant may be premixed with the cheese, or the consumer can mix the colorant with the cheese. When the colorant is premixed with the cheese, the cheese can be provided in individual cheese packages having colored cheese. When the colorant is mixed with the cheese by the consumer, the colorant is provided in a separate package 42 from the cheese and the consumer mixes the colorant from the package 42 with the cheese either prior to application of the cheese to the pizza, or by sprinkling the colorant on the cheese after the cheese has been applied to the pizza.

In one embodiment, the cheese colorant is an edible powder or glitter that is mixed with or sprinkled onto the cheese 20. Glitter is a form of granular colorants. In the case of both powder and glitter colorants, the colorant adheres to the shredded cheese and colors the cheese before the cheese is put on the pizza. The powder and glitter colorants also melt in with or disperse into the cheese as the pizza is baked. The powder or glitter may alternatively be sprinkled on the cheese after the cheese is applied to the pizza, in which case, the powder or glitter melts in and colors the cheese as the cheese melts. Glitter is generally more flake-like than powder. The glitter or powder may be supplied in individual packages 42, each of which corresponds to a particular color. Alternatively, a single colorant package may be provided if only one color is preferred.

Toppings 22 are preferably pre-colored, before application to the pizza 10. Alternatively, a colorant may be sprinkled onto the toppings, if so desired.

FIG. 3 shows an alternative embodiment of the current invention in the form of cheese bread 40. The cheese bread 40 includes two or more layers including a bread or crust 16, a cheese and garlic combination 32, and optional toppings 34. The bread 16 is preferably on the bottom of the stack of layers followed by the cheese combination 32. The toppings 34 are preferably positioned on top. The bread or crust 16, is similar to the crust discussed above, and includes ingredients such as flour, water, oil, salt, yeast, and preservatives, among other ingredients. The cheese combination 32 includes such ingredients as cheese, butter, margarine, salt, garlic, spices, and preservatives, among other ingredients.

The layers of the cheese bread 40 may be color altered, as discussed above in connection with the pizza 10. The traditional color for the bread or crust 16 is light beige to brown, depending upon the degree of baking and the type of ingredients. The color of the cheese mixture 32 can vary depending upon the type of cheese that is utilized in the mixture. A mixture using an orange cheese, such as cheddar, has a light orange original color. A mixture that uses a white cheese, such as mozzarella, provolone, or swiss, has a white/tan original color. The topping 34 can be an accent cheese, such as parmesan or romano, a spice, such as garlic powder, or another type of topping 22, as discussed above. If the topping 34 is a parmesan or romano, the original color of the topping 34 is white or pale yellow. Each of the original colors of the layers can be colored altered from their original color to a red R, blue B, yellow Y, green G, purple P, orange O, white W, or other color.

FIG. 4 shows an alternative embodiment of the invention in the form of a pizza kit 36. The kit 36 has four layers that include: eight (8) crusts 16, eight (8) packages of sauce 18, eight (8) packages of cheese 20, and eight (8) packages of toppings 22. The crusts 16 are preferably partially baked (par-baked), although the crusts may be fully baked for ready to eat products or unbaked, if so desired, the invention not being limited to a partially baked product. Each of the pizza components are preferably packaged in transparent, flexible film materials that are hermetically sealed, but are easily openable by a consumer, either by tearing or cutting. Multiple components may be included in a single sealed package, or each individual component may be individually sealed.

The kit 36 can contain a fewer or a greater number of packages than eight of each component. For example, in an alternative embodiment that utilizes the pizza 12 of FIGS. 1 and 2, three larger, round pizzas, with a corresponding number of sauce 18 packages or cheese 20 packages, are provided. A single package of toppings can be provided, instead of eight individual topping packages 22, if desired. A single package of cheese and a single package of sauce can be provided with multiple crusts, for example, the invention not being limited to the number of individual components or packages of components provided in the kit. A number of different types of toppings may be utilized in a single kit, if desired. An alternative pizza kit (not shown) includes only three layers, excluding the topping layer.

The pizza 14 is assembled by selecting a crust 16, a sauce 18 package, and a cheese 20 package. The sauce 18 is spread onto the upper surface of the crust 16 and the cheese 20 is sprinkled over the sauce 18. Toppings may be positioned on top of the cheese 20. Alternatively, toppings may be positioned on top of the sauce 18, with the cheese 20 being sprinkled over the sauce 18. Toppings are optional. In addition, another topping (not shown) may also be utilized, such as a garlic salt or another spice, or an additional cheese.

Each of the crust 16, sauce 18, cheese 20, and topping packages may contain a product that has been color altered. It is preferred that at least one of the layers of the pizza 10 is color altered. But any number of the layers can be color altered. For example, the crusts 16 can be color altered while the remainder of the layers are their traditional, original color. The crusts 16 and sauce 18 can be color altered while the remainder of the layers are their traditional, original color. The crusts 16, sauce 18, and cheese 20 can be color altered while the toppings remain their traditional, original color. Alternatively, all layers can be color altered. Other combinations of color altered and original, traditional layers are also available, according to the invention.

In a preferred embodiment of the kit 36, each of the layers comprises more than one color. For instance, in a kit 36 having eight crusts 16, as shown in FIG. 4, two crusts 16 of each selected color are provided, such as two red R, two blue B, two green G, and two purple P. The same is true for the sauce 18 packages and cheese 20 packages. It is desirable to provide a number of different colors of each layer so that the consumer can pick and choose among the various colors when assembling the pizza 10. As an example, the consumer may select a purple P crust 16, a green G sauce 18, and a blue B cheese 20. In another pizza 10, the consumer may select a blue B crust 16, an uncolored red sauce, and an uncolored white cheese, to make a red, white, and blue B pizza 10. Many alternative combinations are possible, the invention not being limited to a particular combination.

As discussed above, the cheese 20 packages may include cheese 20 that is already color altered, or may include natural cheese having its traditional color and a colorant package. With the latter, the colorant package may be separate from the cheese 20 package, or may be included within the same package bundle. The consumer, upon selecting a colorant, mixes the cheese 20 with the colorant (which can be accomplished in the package that the cheese 20 is provided in), or sprinkles the colorant on top of the cheese 20 once the cheese 20 is positioned on the pizza 10.

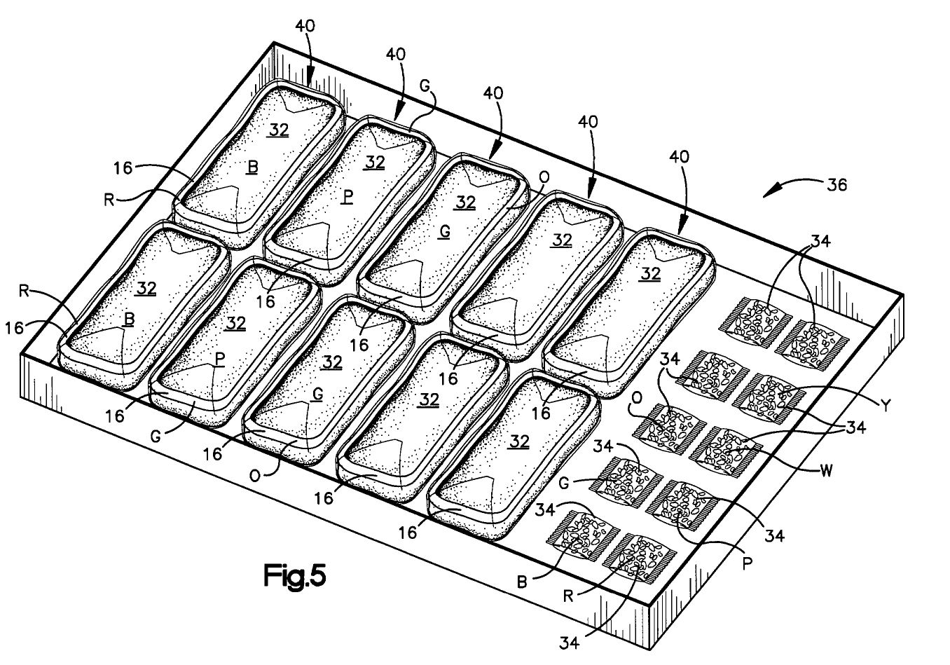

FIG. 5 shows another embodiment of the invention in the form of a cheese bread kit 38. The cheese bread 40 has several layers, including a bread or crust 16, a cheese and garlic combination layer 32, and an optional topping 34. Ten crusts 16, ten cheese and garlic layers 32, and ten topping 34 packages are provided in the kit 36. The cheese and garlic combination layer 32 is preferably already assembled on the crust 16 when provided to the consumer in the kit 38. The topping 34 can be applied by the consumer. In this embodiment, the crusts 16, cheese and garlic combination 32, and toppings 34 each may be color altered from their traditional, original color. And different combinations of the colors may be provided to the consumer. For instance, the kit 38 may include crusts 16 of five different colors, cheese and garlic layers 32 of five different colors, and topping packages 34 of five different colors. The user can select the crust/cheese and garlic color combination, and then position a selected topping 34 on top of the cheese bread 40. Alternatively, the crust 16 and cheese/garlic layers 32 can have their traditional colors (light beige to brown for the crust 16 and light orange or white/tan for the cheese), and the toppings 34 can be provided in a number of different colors. A topping 34 can be an accent cheese, like parmesan or romano, or a garlic salt or other spice, among other topping choices, as discussed above.

In addition to the above, kits 36, 38 may be provided that have some of the components color altered and some in their traditional color. For example, a kit can have some color altered crusts and some traditionally colored crusts. In addition, it is not necessary that an even number of colors be provided for each component. For example, the kit shown in FIG. 4 could have two differently colored crusts, 4 differently colored sauces, and eight differently colored toppings.

The pizza kit 36 may also include an activity kit that can be used by the consumer, for example, while the individual pizzas are baking. The activity kit may include, for example, crayons, games, books, or other materials, the invention not being limited to a particular item in the activity kit or to the inclusion of an activity kit.

The invention may also be utilized with other types of layered products. For example, cheese and cracker kits that require user assembly can be color altered so that the user can select differently colored cheeses with differently colored crackers. Multi-layered dessert products may also utilize the invention. For example, a dessert product having a bread or crust 16, a cream cheese layer, and a fruit topping can have the various layers color altered from their traditional, original color, similarly to that discussed in connection with FIG. 4. Other types of products may also derive a benefit from the present invention, the invention not being limited to the depicted embodiments.

Examples of the various products described above, but in an uncolor-altered state include Desert Delight, Chee-zee Bread, Sr. Pizza Kit and Jr. Pizza Kit, all manufactured by Joe Corbi's Wholesale Pizza, Inc.

Furthermore, the various components of the invention have been described in the context of “packages.” However, the term “package” should be construed broadly herein to refer to any separately presented components, regardless of how they are actually packaged. For example, the various components can be packaged in individual plastic wrapped packages. Alternatively, the various components may be housed in a single plastic or other container that has separate compartments for each component. Therefore, while the term “package” has been used herein, it should be construed broadly to mean any type of packaging that provides at least some of the components in a separated form.

While various features of the claimed invention are presented above, it should be understood that the features may be used singly or in any combination thereof. The claimed invention is not to be limited to only the specific embodiments depicted herein. It should be understood that variations and modifications may occur to those skilled in the art. The embodiments described herein are exemplary of the claimed invention. The disclosure may enable those skilled in the art to make and use embodiments having alternative elements that likewise correspond to the elements of the invention recited in the claims. The intended scope of the invention may thus include other embodiments that do not differ or that insubstantially differ from the literal language of the claims. The scope of the present invention is accordingly defined as set forth in the appended claims.

What is claimed is:

1. A pizza comprising:
a crust having a first color and a traditional color;
a sauce having a second color and a traditional color; and
a cheese having a third color and a traditional color, wherein at least one of the first color, the second color, and the third color are fundamentally different from the corresponding traditional color.

2. The pizza of claim 1, wherein each of the first color, the second color, and the third color are fundamentally different from the corresponding traditional color.

3. The pizza of claim 1, wherein the first color is fundamentally different from the traditional color of the crust and the crust comprises a dough and a crust colorant, wherein the dough and the crust colorant are combined together to form the crust, with the dough having a traditional color and the crust colorant having the first color, wherein when the crust colorant is combined with the dough, the dough takes on the first color, and the first color comprises at least one of red, blue, green, purple, yellow, and orange.

4. The pizza of claim 1, wherein the second color is fundamentally different from the traditional color of the sauce and the sauce comprises a base sauce and a sauce colorant, wherein the base sauce and the sauce colorant are combined together to form the sauce, with the base sauce having a traditional color and the sauce colorant having the second color, wherein when the sauce colorant is combined with the base sauce, the sauce takes on the second color, and the second color comprises at least one of red, blue, green, purple, yellow, and orange.

5. The pizza of claim 1, wherein the third color is fundamentally different from the traditional color of the cheese and the cheese comprises a base cheese and a cheese colorant, wherein the base cheese and the cheese colorant are combined together to form the cheese, with the base cheese having a traditional color and the cheese colorant having the third color, wherein when the cheese colorant is combined with the base cheese, the cheese takes on the third color, and the third color comprises at least one of red, blue, green, purple, yellow, and orange.

6. The pizza of claim 1, further comprising a topping having a fourth color and a traditional color.

7. The pizza of claim 6, wherein the fourth color is fundamentally different from the traditional color of the topping.

8. The pizza of claim 6, wherein the topping comprises at least one of cheese, meat, or vegetables.

9. The pizza of claim 6, wherein the fourth color comprises at least one of red, blue, green, purple, yellow, and orange.

10. The pizza of claim 2, wherein the crust comprises a pizza dough and a crust colorant, the sauce comprises a base sauce and a sauce colorant, and the cheese comprises a base cheese and a cheese colorant.

11. The pizza of claim 10, wherein the crust colorant is at least one of a powder, a granular, or a liquid colorant, the sauce colorant is at least one of a powder, a granular, or a liquid colorant, and the cheese colorant is at least one of a powder, a granular, or a liquid colorant.

12. The pizza of claim 10, wherein the crust colorant is a dye or a pigment, the sauce colorant is a dye or a pigment, and the cheese colorant is a dye or a pigment

13. The pizza of claim 1, wherein the first color comprises at least one of red, blue, green, purple, yellow, and orange, the second color comprises at least one of red, blue, green, purple, yellow, and orange, and the third color comprises at least one of red ,blue, green, purple, yellow, and orange.

14. A multi-layered food product comprising:
a first food layer having a first color and a traditional color, with the first color being fundamentally altered from the traditional color of the first food layer;
a second food layer having a second color and a traditional color, with the second color being fundamentally altered from the traditional color of the second food layer.

15. The multi-layered food product of claim 14, further comprising a third food layer having a third color and a traditional color, with the third color being fundamentally altered from the traditional color of the third food layer.

16. The multi-layered food product of claim 14, wherein the first food layer is a bread, and the second food layer is a mixture comprising at least cheese and garlic.

17. A cheese bread kit according to claim 16, comprising a plurality of multi-layered food products, wherein at least some of the plurality of multi-layered food products have different colored first and second layers than others of the plurality of multi-layered food products.

18. The multi-layered food product of claim 14, wherein the first food layer is a bread, the second food layer is a cream-cheese food product, and further comprising a third food layer having a third color, wherein the third layer is a fruit.

19. The multi-layered food product of claim 15, wherein the first food layer is a crust, the second food layer is a sauce, and the third food layer is a cheese.

20. The multi-layered food product of claim 14, wherein the first color is at least one of red, blue, green, purple, yellow, and orange; and the second color is at least one of red, blue, green, purple, yellow, and orange.

21. The multi-layered food product of claim 14, wherein the first food layer is a crust, and the second food layer is a sauce, and further comprising a third food layer having a third color, wherein the third food layer is a cheese.

22. The multi-layered food product of claim 14, wherein the first food layer is a crust, and the second food layer is a cheese, and further comprising a third food layer having a third color, wherein the third food layer is a sauce.

23. A pizza kit comprising:
at least one package comprising a crust having at least one first color and an original color;
at least one package comprising a sauce having at least one second color and an original color; and
at least one package comprising a cheese having at least one third color and an original color, wherein at least one of the first color, the second color, and the third color are fundamentally different from their corresponding original color.

24. The pizza kit of claim 23, wherein the at least one first color is the same as the crust original color, the at least one second color is the same as the sauce original color, and the at least one third color is different from the cheese original color.

25. The pizza kit of claim 23, wherein the at least one package of crusts comprises a plurality of crusts.

26. The pizza kit of claim 23, wherein the plurality of crusts are sealed in a single package.

27. The pizza kit of claim 23, wherein the at least one package of crust comprises a plurality of packages of crusts, the at least one package of sauce comprises a plurality of packages of sauce, and the at least one package of cheese comprises a plurality of packages of cheese.

28. The pizza kit of claim 27, wherein the at least one first color comprises a plurality of first colors, such that at least some of the plurality of packages of crusts have a different first color than others of the plurality of crusts; the at least one second color comprises a plurality of second colors, such that at least some of the plurality of packages of sauce have a different second color than others of the packages of sauce; and the at least one third color comprises a plurality of third colors, such that at least some of the plurality of packages of cheese have a different third color than others of the packages of cheese, whereby the various colors of crust, sauce, and cheese allow a consumer to select differently colored pizza combinations.

29. The pizza kit of claim 28, wherein the first color comprises at least four different colors, the second color comprises at least four different colors, and the third color comprises at least four different colors.

30. The pizza kit of claim 23, wherein the at least one first color is different from the crust original color, the at least one second color is different from the sauce original color, and the at least one third color is the same as the cheese original color.

31. The pizza kit of claim 27, wherein the plurality of packages of cheese comprise a plurality of packages of a shredded cheese having a traditional color and a plurality of packages of cheese colorant having the second color that is different from the original cheese color, wherein a combination of one of the packages of cheese with one of the packages of colorant results in a cheese that has the second color.

32. The pizza kit of claim 23, further comprising an activity kit including at least one of crayons, puzzles, and books.

33. A multi-layered food product kit comprising:
a plurality of first food layers, each having a color that is fundamentally different from a traditional color of the first food layer; and
a plurality of second food layers, each having a color that is fundamentally different from a traditional color of the second food layer.

34. The multi-layered food product kit of claim 33, further comprising a plurality of third food layers having a color that is fundamentally different from a traditional color of the third food layer.
